(19) United States
(12) Patent Application Publication
(10) Pub. No.: US 2011/0032955 A1
(43) Pub. Date: Feb. 10, 2011

(54) Small Packaged Tunable Laser

(75) Inventor: Andrew John Daiber, Emerald Hills, CA (US)

Correspondence Address: EMCORE CORPORATION, 1600 EUBANK BLVD, S.E., ALBUQUERQUE, NM, 87123, US

(73) Assignee: EMCORE Corporation, Albuquerque, NM (US)

(21) Appl. No.: 12/722,825

(22) Filed: Mar. 12, 2010

Related U.S. Application Data
(63) Continuation-in-part of application No. 12/537,026, filed on Aug. 6, 2009.

(51) Int. Cl. H01S 3/10; H01S 3/04

(52) U.S. Cl. 372/20; 372/34

(57) ABSTRACT

According to one embodiment, the present application includes a tunable laser configured in a small package. The tunable laser includes a housing with a volume formed by exterior walls. An electrical input interface is positioned at the first end of the housing and configured to receive an information-containing electrical signal. An optical output interface is positioned at the second end of the housing and configured to transmit a continuous wave optical beam. A tunable semiconductor laser is positioned in the interior space and operable to emit a laser beam having a selectable wavelength. A focusing lens assembly is positioned in the interior space along an optical path of the laser beam to operatively couple the laser beam to the optical output interface.

### PRIORITY CLAIM

This application is a continuation-in-part of U.S. patent application Ser. No. 12/537,026, filed 6 Aug. 2009 and entitled “SMALL PACKAGED TUNABLE OPTICAL TRANSMITTER,” the content of which is incorporated by reference herein in its entirety.

### FIELD OF THE INVENTION

The present application is directed to a tunable laser and, more particularly, to a small, packaged tunable laser.

### BACKGROUND

Tunable lasers may be packaged as a component of an optical transceiver, or may be used in other applications outside of an optical transceiver. Tunable lasers are generally packaged with other components including an electrical interface and an optical interface.

There is an ever-constant challenge in the industry to reduce the size of tunable laser packages. The reduction in size may allow lasers to be used in a greater number of applications. The reduction in size provides numerous design challenges for the package components to fit within the limited space and also not compromise performance or reliability.

In applications in which tunable lasers are a component of an optical transceiver, the tunable lasers should be sized for use with one of the various form factors. The various form factors provide standardized dimensions and electrical input/output interfaces that allow devices from different manufacturers to be used interchangeably. Examples of form factors include but are not limited to XENPAK, SFF (“Small Form Factor”), SFP (“Small Form Factor Pluggable”), and XFP (“10 Gigabit Small Form Factor Pluggable”).

Therefore, there is a need for a small, packaged tunable laser for various applications.

### SUMMARY

The present application is directed to tunable lasers configured in a small package. The tunable lasers may include a rectangular housing, an electrical input interface, an optical output interface, a tunable semiconductor laser and a focusing lens assembly. The rectangular housing has a volume of less than 0.6 cubic centimeters, with six planar exterior walls including a bottom, a top, opposing first and second ends, and opposing sidewalls. The exterior walls form a hermetically sealed interior space that includes a major axis that extends through the first and second ends. The electrical input interface is positioned at the first end of the housing and aligned with the major axis. The electrical interface is configured to receive an information-containing electrical signal. The optical output interface is positioned at the second end of the housing and aligned with the major axis. The optical interface is configured to transmit a continuous wave optical beam. The tunable semiconductor laser is positioned in the interior space and operable to emit a laser beam having a selectable wavelength. The focusing lens assembly is positioned in the interior space along an optical path of the laser beam to operatively couple the laser beam to the optical output interface.

The present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a perspective view of a small, packaged tunable laser according to one embodiment.

FIG. 2 is a schematic diagram of a tunable laser according to one embodiment.

FIG. 3 is a perspective view of laser components according to one embodiment.

### DETAILED DESCRIPTION

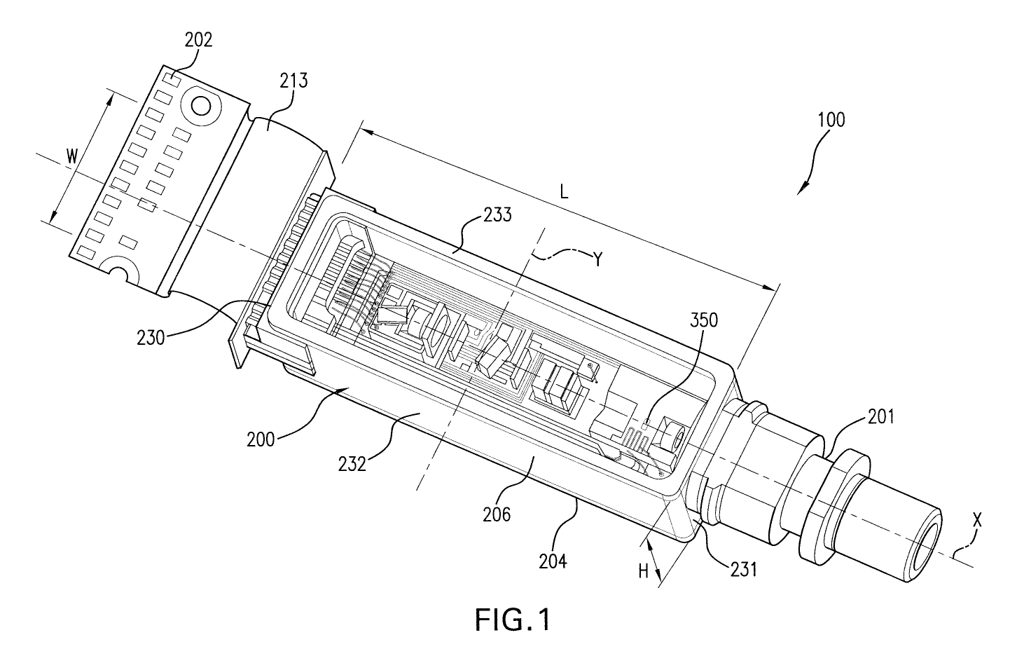

The present application is directed to a small, packaged tunable laser 100 as illustrated in FIG. 1. The tunable laser 100 is packaged in a housing 200 that forms an interior space for housing the laser components 300. The laser 100 includes an overall small size for use in optical transceivers and various other applications.

The housing 200 includes a generally rectangular body 206 with exterior walls that forms a substantially rectangular shape. The body 206 includes a bottom 204, a cover (not illustrated), first and second ends 230, 231, and opposing sidewalls 232, 233. The cover may be substantially planar and positioned on the top surfaces of the first and second ends 230, 231 and opposing sidewalls 232, 233. In one embodiment, the cover is substantially identical to the bottom 204.

The housing 200 includes a substantially rectangular shape with a width W formed by the opposing sidewalls 232, 233, a length L formed by the first and second ends 230, 231, and a height H that extends between the bottom 204 and top of the sidewalls 232, 233 and ends 230, 231. The housing 200 may include various sizes. In one specific embodiment, the width W is about 5.4 mm, the length L is about 17.1 mm, and the height H is about 5.9 mm. The volume of the interior space formed by the housing 200 may also vary depending upon the application. Exemplary volumes may range from between about 400 mm³ to about 600 mm³. In one specific embodiment, the volume is about 545 mm³. The housing 200 includes an elongated shape with a major axis X extending along the length L through the first and second ends 230, 231, and a minor axis Y perpendicular to the major axis and extending through the opposing sidewalls 232, 233. The housing 200 may be hermetically sealed to protect the laser components 300 from humidity and other environmental conditions.

An electrical input interface 202 extends outward from the first end 230 of the housing 200. The electrical interface 202 is configured to receive information-containing electrical signals. In the embodiment of FIG. 1, the electrical interface 202 includes a flexible cable 213 that is aligned with the major axis X, and includes various connections. The electrical interface 202 may also include additional flexible cables 213 that extend outward from the first end 230, or sidewalls 232, 233.

An optical output interface 201 extends outward from the second end 231 of the housing 200. In one embodiment, the optical output interface 201 is aligned with the major axis X of the housing 200. The optical output interface 201 is configured to transmit a continuous wave optical beam that is emitted from the laser components 300.

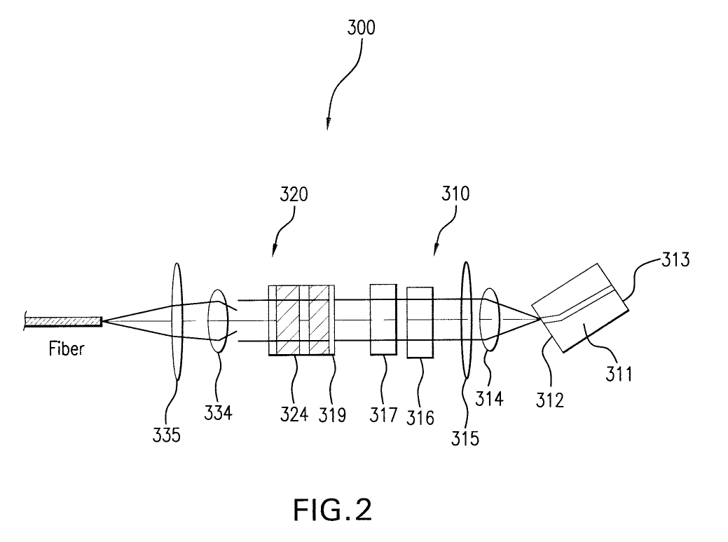

The laser components 300 generally include an external cavity laser 310 and coupling optics 320. FIG. 2 schematically illustrates the laser components 300 according to one embodiment.

The external cavity laser 310 includes a diode gain chip 311 comprising a Fabry-Perot diode laser with a substantially non-reflective front facet 312 and a highly reflective rear facet 313. The gain chip 311 may also include a bent-waveguide structure. The external cavity laser 310 also includes a collimating lens 314, a steering lens 315, a tunable filter 316, a cavity length actuator 317, and a reflective element 319. Possible implementations of the tunable filter 316 include but are not limited to Bragg gratings, Fabry-Perot etalons, and liquid crystal waveguides. The actuator 317 may use thermal, mechanical, or electro-optical mechanisms to adjust the optical pathlength of the laser cavity. The actuator 317 may also lock the optical pathlength.

The external cavity tunable laser 310 may be configured with the tunable filter 316 being decoupled from the gain chip 311. This configuration results in the tunable filter 316 being very stable and therefore does not require an external wavelength locker as required in Distributed Feedback (DFB) lasers and Distributed Bragg Reflector (DBR) lasers. Other advantages of the external cavity tunable laser 310 over these other lasers are the extremely narrow linewidth and very high side mode suppression ratio.

The coupling optics 320 provide isolation and data modulation. The coupling optics 320 efficiently couple light from the gain chip 311 to the optical output interface 201. A total optical magnification of the coupling optics 320 and the external cavity lenses 314, 315 is chosen to correct for the difference between mode field diameters of the gain chip 311. The coupling optics 320 includes an optical isolator 324. The optical isolator 324 may include a two-stage isolator that prevents light reflected from a collimating lens 334 and a steering lens 335 from getting back into the external cavity tunable laser 310. The isolator 324 may also rotate a light polarization by 90 degrees to improve transmission. In one embodiment, the optical path is aligned substantially along the major axis X of the housing 200.

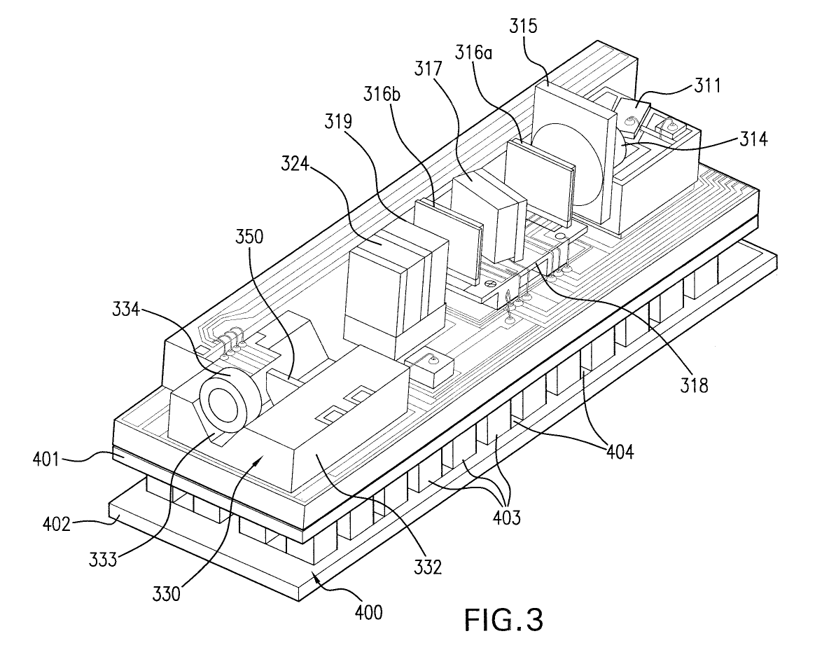

FIG. 3 illustrates a perspective view of a focusing lens assembly 330. The lens assembly 330 includes a micro-optical bench 332 with an etched V-groove 333. Collimating lens 334 is positioned in the V-groove 333. A photodiode 350 is mounted on the bench 332 between the optical isolator 324 of the coupling optics 320 and the optical output interface 201. The bench 332 provides a compact solution for passive lens positioning in the transverse optical plane and may be constructed from a variety of materials, including but not limited to silicon. Axial positioning of the collimating lens 334 may be actively controlled using current output by the photodiode 350 as a feedback signal. In one embodiment, a beam-splitter (not shown) is positioned between the optical isolator 324 and the photodiode for directing a small portion (e.g. 5%) of the isolator output to the photodiode for sensing the tunable laser output and directing the remainder of the isolator output to the collimating lens 334.

A thermoelectric cooler 400 provides a base for supporting the various elements of the tunable laser 100. In one embodiment, the cooler 400 is positioned between the bottom 204 of the housing 200 and one or more of the laser components 300 and/or the focusing lens assembly 330. The thermoelectric cooler 400 includes first and second plates 401, 402 separated by intermediate members 403. The plates 401, 402 may be constructed from a variety of materials, including ceramics. The intermediate members 403 each include a first end operatively connected to the first plate 401 and a second end operatively connected to the second plate 402. The intermediate members 403 are electrically connected in series by connectors 404. The intermediate members 403 are constructed from semiconductor material that allows for electron flow through the member 403 when connected to a DC power source. In use, as the DC power source is activated and a current passes through the series of intermediate members 403, the current causes a decrease in temperature at the first plate 401 that absorbs heat from the laser components 300 and/or the focusing lens assembly 330. The heat is transferred through the plate 401 and intermediate members 403 into the second plate 402. This heat may then be transferred from the second plate 402, such as to a heat sink.

The temperature of the focusing lens assembly 330 may be separately controlled from the other laser components 300. The micro-optical bench 332 may act as a thermal insulator to insulate the lens assembly 330 from the effects of the thermoelectric cooler 400. The lens assembly 330 may also include a local resistive heater and a closed-loop temperature control circuit to independently control the temperature. Likewise, the temperature of the tunable filter 316 and cavity length actuator 317 may be separately controlled from the other laser components 300. A bench 318 may provide thermal isolation from the thermoelectric cooler 400.

The embodiment of the laser components 300 of FIG. 3 also includes a tunable filter 316 with a pair of spaced apart tunable etalons 316a, 316b. The etalons 316a, 316b are Fabry-Perot spaced etalons that are positioned in a parallel configuration. The first etalon 316a includes a thickness measured between opposing faces and a refractive index according to the material from which it is constructed. The second etalon 316b includes a thickness measured between its opposing faces and a refractive index according to the material from which it is constructed. The etalons 316a, 316b may be constructed from the same or different materials, and may include the same or different thicknesses. Etalons 316a, 316b may be constructed from various materials, such as but not limited to silicon and gallium arsenide. One or both etalons 316a 316b are tunable by a temperature-induced change in their refractive indexes and/or a temperature-induced change in their thickness. In one embodiment, the etalons 316a, 316b are tunable by simultaneous control of both the refractive index and the physical thickness.

One example of a tunable laser is disclosed in U.S. Pat. No. 7,257,142, herein incorporated by reference.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A small, packaged tunable laser comprising:
a rectangular housing having a volume of less than 0.6 cubic centimeters, with six planar exterior walls including a bottom, a top, opposing first and second ends, and opposing sidewalls, the exterior walls forming a hermetically sealed interior space that includes a major axis that extends through the first and second ends;
an electrical input interface positioned on the exterior of the housing and configured to receive an information-containing electrical signal;
an optical output interface positioned at the second end of the housing and aligned with the major axis, the optical output interface configured to transmit a continuous wave optical beam;
a tunable semiconductor laser positioned in the interior space and operable to emit a laser beam having a selectable wavelength; and
a focusing lens assembly positioned in the interior space along an optical path of the laser beam to operatively couple the laser beam to the optical output interface.

2. The tunable laser of claim 1, wherein the electrical input interface includes at least one flexible cable that extends outward from the housing.

3. The tunable laser of claim 1, wherein the optical path is aligned along the major axis.

4. The tunable laser of claim 1, further comprising coupling optics positioned in the interior space along the optical path between the semiconductor laser and the focusing lens assembly, the coupling optics including a pair of coupling lenses and an isolator.

5. The tunable laser of claim 4, further comprising a photodiode disposed between the coupling optics and the optical output interface.

6. The tunable laser of claim 1, wherein the semiconductor laser is an external cavity tunable laser that includes a tunable filter.

7. The tunable laser of claim 6, further including a cavity length actuator to adjust and lock an optical pathlength of the external cavity tunable laser.

8. The tunable laser of claim 4, further including a thermoelectric cooler positioned within the interior space between the bottom of the housing and at least one of the tunable semiconductor laser and the coupling optics.

9. A small, packaged tunable laser comprising:
a rectangular housing with six planar sides including a bottom, top, first end, second end, and two opposing sidewalls, the housing including a hermetically sealed interior space with a length measured between the first and second ends and a width measured between the opposing sidewalls, the length being larger than the width;
laser components positioned in the interior space and including coupling optics and an external cavity laser with a tunable filter, the laser components aligned within the interior space with an optical path of a laser beam that emanates at the external cavity laser and extends along the coupling optics substantially perpendicular to the first and second ends and along a portion of the length of the housing;
an electrical input interface positioned at the first end of the housing and configured to receive an information-containing electrical signal; and
an optical output interface positioned at the second end of the housing and configured to transmit a continuous wave optical signal.

10. The tunable laser of claim 9, further including a thermoelectric cooler positioned within the interior space between the bottom of the housing and the laser components.

11. The tunable laser of claim 9, wherein the external cavity laser further includes a cavity length actuator to adjust an optical pathlength of the external cavity tunable laser.

12. The tunable laser of claim 9, further comprising a focusing lens assembly positioned in the interior space along the optical path to operatively couple the laser beam to the optical output interface.

13. The tunable laser of claim 12, wherein the coupling optics are positioned in the interior space along the optical path between the external cavity laser and the focusing lens assembly, the coupling optics including a pair of coupling lenses and an isolator.

14. The tunable laser of claim 13, further comprising a photodiode disposed between the coupling optics and the optical output interface.

15. The tunable laser of claim 9, wherein the housing has a volume of about 0.55 cubic centimeters.
